(19) United States
(12) Patent Application Publication
(10) Pub. No.: US 2003/0124360 A1
(43) Pub. Date: Jul. 3, 2003

(54) Substrate with a reduced light-scattering, ultraphobic surface and method for the production of the same

(76) Inventors: Karsten Reihs, Koln (DE); Angela Duparre, Jena-Kunitz (DE); Gunther Notni, Jena (DE)

Correspondence Address: PERMAN & GREEN, 425 POST ROAD, FAIRFIELD, CT, 06824, US

(21) Appl. No.: 10/304,619

(22) Filed: Nov. 26, 2002

Related U.S. Application Data
(63) Continuation-in-part of application No. PCT/EP01/05942, filed on May 23, 2001.

(30) Foreign Application Priority Data
May 26, 2000 (DE) 100 26 299.6

(51) Int. Cl. B32B 17/06; B32B 9/00

(52) U.S. Cl. 428/432; 428/698; 428/702; 428/336

(57) ABSTRACT

The invention relates to a substrate with a reduced light-scattering, ultraphobic surface, to a method for the production of said substrate and to the use thereof. The substrate with a reduced light-scattering, ultraphobic surface has a total scatter loss ≦7%, preferably ≦3% and especially ≦1% and a contact angle in relation to water of ≧140°, preferably ≧150°.

This invention relates to a substrate with a reduced light-scattering, ultraphobic surface, a method for the production of said substrate and the use thereof.

The invention also relates to a screening method for the production of such a substrate. The substrate with a reduced light-scattering, ultraphobic surface has a total scatter loss of ≦7%, preferably ≦3%, particularly preferably ≦1%, and a contact angle in relation to water of at least 140°, preferably at least 150°, and a roll-off angle of ≦20°.

Ultraphobic surfaces are characterised by the fact that the contact angle of a drop of a liquid, usually water, lying on the surface is significantly more than 90° and that the roll-off angle does not exceed 20°. Ultraphobic surfaces with a contact angle of ≧140° and a roll-off angle of ≦20° are very advantageous technically because, for example, they cannot be wetted with water or oil, dirt particles are poorly adherent to these surfaces and the surfaces are self-cleaning. Here, self-cleaning should be understood to mean the ability of the surface readily to relinquish dirt or dust particles adhering to the surface into liquids flowing over the surface.

Here, the roll-off angle should be understood to mean the angle of inclination of a fundamentally planar but structured surface relative to the horizontal at which a stationary water droplet with a volume of 10 μl is moved due to the force of gravity if the surface is inclined by the roll-off angle.

For the purposes of the invention, a hydrophobic material is a material which on a flat, non-structured surface has contact angle relative to water of more than 90°.

For the purposes of the invention, an oleophobic material is a material which on a flat, non-structured surface has a contact angle in relation to long-chain n-alkanes, such as n-decane, of more than 90°.

For the purposes of the invention, a reduced light-scattering surface designates a surface on which the scatter losses caused by roughness, determined according to the standard ISO/DIS 13696, is ≦7%, preferably ≦3%, particularly preferably ≦1%. The measurement is performed at a wavelength of 514 nm and determines the total scatter losses in the forward and backward directions. The precise method is described in the publication by A. Duparr\acute{e} and S. Gliech, Proc. SPIE 3141, 57 (1997), which is cited here as a reference and hence is part of the disclosure.

In addition, the reduced light-scattering ultraphobic surface preferably has high abrasion resistance and scratching resistance. Following exposure to abrasion using the Taber Abraser method according to ISO 3537 with CS10F abrading wheels, 500 cycles with a weight of 500 g per abrading wheel, an increase in haze of ≦10%, preferably ≦5% occurs. After exposure to scratching with the sand trickling test (Sandrieseltest) according to DIN 52348, an increase in haze of ≦15%, preferably ≦10%, particularly preferably ≦5% takes place. The increase in haze is measured in accordance with ASTM D 1003. To measure haze, the substrate with the surface is irradiated with visible light and the scattered fractions responsible for the haze determined.

There has been no shortage of attempts to provide ultraphobic surfaces. For example, EP 476 510 A1 discloses a method for the production of a hydrophobic surface in which a metal oxide film with a perfluorinated silane is applied to a glass surface. However, the surfaces produced with this method have the drawback that the contact angle of a drop on the surface is less than 115°.

Methods for the production of ultraphobic surfaces are also known from WO 96/04123. This patent application explains inter alia how to produce synthetic surface structures from elevations and indentations whereby the distance between the elevations is in the range from 5 to 200 μm and the height of the elevations is in the range of from 5 to 100 μm. However, surfaces roughened in this way have the disadvantage that due to their size the structures result in intensive light scattering, causing the objects to appear extremely hazy in terms of transparency or very matt in terms of gloss. This means that such objects cannot be used for transparent applications, such as for example, the production of glass for transport vehicles or for buildings.

Also explained in U.S. Pat. No. 5,693,236 are several methods for the production of ultraphobic surfaces in which microneedles of zinc oxide are applied with a binder to a surface and then partially uncovered in a different way (e.g. by means of plasma treatment). The surface roughened in this way is then coated with a water-repellent means. Surfaces structured in this way have contact angles of up to 150°. However, due to the size of the unevennesses, here the surface is extremely light-scattering.

A publication by K. Ogawa, M. Soga, Y. Takada and I. Nakayama, Jpn. J. Appl. Phys. 32, 614-615 (1993) describes a method for the production of a transparent, ultraphobic surface in which a glass plate is roughened with a radio frequency plasma and coated with a fluorine-containing silane. It is suggested that the glass plate be used for windows. The contract angle for water is 155°. However, the method described has the disadvantage that the transparency is only 92% and the size of the structures produced causes haze due to scatter losses. In addition, the roll-off angle for water droplets with a volume of 10 μl is still approximately 35°.

Therefore, the object is to provide transparent substrates in which there is no impairment of transparency due to haze and non-transparent substances with a high surface gloss whereby the substrates are ultraphobic.

In order, for example, to facilitate use as screens in cars or windows in buildings, the surface must preferably simultaneously have good resistance to scratching or abrasion. After exposure to abrasion using the Taber Abrasion method according to ISO 3537 (500 cycles, 500 g per abrading wheel, CS10F abrading wheels), the maximum increase in haze should be ≦10%, preferably ≦5%. After exposure to scratching in the sand trickling test according to DIN 52348, the increase in haze should be ≦15%, preferably ≦10%, particularly preferably ≦5%. The increase in haze following the two stresses is determined according to ASTM D 1003.

One particular problem is the fact that surfaces with reduced light scattering which are to be simultaneously ultraphobic may be produced with a wide variety of materials with extremely different surface topographies, as is evident from the examples cited above. In addition, substrates with reduced light scattering and ultraphobic surfaces may also be produced with extremely different types of coating processes. Finally, matters are particularly complicated by the fact that the coating processes must be performed with specific precisely defined process parameters.

Therefore, there is still no screening method suitable to determine the materials, coating processes and process parameters of the coating processes with which substrates with reduced light-scattering and ultraphobic surfaces may be produced.

The object is achieved according to the invention with a substrate with a reduced light-scattering and ultraphobic surface, which is the subject of the invention, in which the total scatter loss is ≦7%, preferably ≦3%, particularly preferably ≦1% and the contact angle in relation to water is ≧140°, preferably ≧150°. The substrate with a reduced light-scattering and ultraphobic surface is, for example, produced using the method described in the following which in turn may be found by a rapid screening method consisting of selection steps, calculation steps and production steps.

The ultraphobic surface or its substrate preferably comprises plastic, glass, ceramic material or carbon.

Preferred is a substrate with abrasion resistance determined by the increase in haze according to test method ASTM D 1003 of ≦10%, preferably ≦5%, in relation to abrasion stress using the Taber Abrasion method according to ISO 3537 with 500 cycles, a weight of 500 g per abrading wheel and CS10F abrading wheels.

Also preferred is a substrate with scratch resistance determined from the increase in haze according to ASTM D 1003 of ≦15%, preferably ≦10%, particularly preferably ≦5%, in relation to scratch stress with the sand trickling test according to DIN 52348.

Also preferred is a substrate characterised in that, for a water droplet with a volume of 10 μl, the roll-off angle is ≦20° on the surface.

a) Plastics

Particularly suitable for the ultraphobic surface and/or its substrate is a thermosetting or thermoplastic plastic.

The thermosetting plastic is in particular selected from the following series: diallyl phthalate resin, epoxy resin, urea-formaldehyde resin, melamine-formaldehyde resin, melamine-phenolic-formaldehyde resin, phenolic-formaldehyde-resin, polyimide, silicone rubber and unsaturated polyester resin.

The thermoplastic plastic is in particular selected from the series: thermoplastic polyolefin, e.g. polypropylene or polyethylene, polycarbonate, polyester carbonate, polyester (e.g. PBT or PET), polystyrene, styrene copolymer, SAN resin, rubber-containing styrene graft copolymer, e.g. ABS polymer, polyamide, polyurethane, polyphenylene sulphide, polyvinyl chloride or any possible mixtures of said polymers.

In particular suitable as the substrate for the surface according to the invention are the following thermoplastic polymers:

polyolefins, such as polyethylene of high and low density, i.e. densities of 0.91 g/cm³ to 0.97 g/cm³ which may be prepared by known methods, Ullmann (4^{th} Edition) 19, page 167 et seq, Winnacker-Kückler (4^{th} Edition) 6, 353 to 367, Elias and Vohwinkel, Neue Polymere Werkstoffe für die Industrielle Anwendung (New polymeric materials for industrial use), Munich, Hanser 1983.

Also suitable are polypropylenes with molecular weights of 10,000 g/mol to 1,000,000 g/mol which may be prepared by known methods, Ullmann (5^{th} Edition) A10, page 615 et seq, Houben-Weyl E20/2, page 722 et seq, Ullmann (4^{th} Edition) 19, page 195 et seq, Kirk-Othmer (3^{rd} Edition) 16, page 357 et seq.

However, also possible are copolymers of the said olefins or with other α-olefins, such as for example:

polymers of ethylene with butene, hexane and/or octane

EVAs (ethylene-vinyl acetate copolymers), EEAs (ethylene-ethyl acrylate copolymers), EBAs (ethylene-butyl acrylate copolymers), EASs (acrylic acid-ethylene copolymers), EVKs (ethylene-vinyl carbazole copolymers), EPBs (ethylene-propylene block copolymers), EPDMs (ethylene-propylene-diene copolymers), PBs (polybutylenes), PMPs (polymethylpentenes), PIBs (polyisobutylenes), NBRs (acrylonitrile butadiene copolymers), polyisoprenes, methyl-butylene copolymers, isoprene isobutylene copolymers.

Production method: polymers of this type have been disclosed, for example, in Kunststoff-Handbuch (Plastics Handbook), Vol. IV. Hanse Verlag, Ullmann (4^{th} Edition), 19, page 167 et seq,

Winnacker-Kückler (4^{th} Edition), 6, 353 to 367

Elias and Vohwinkerl, Neue Polymere Werkstoffe (New Polymeric Materials), Munich, Hanser 1983,

Franck and Biederbick, Kunststoff Kompendium (Plastics Compendium) Wurzburg, Vogel 1984.

According to the invention, suitable thermoplastic plastics also include thermoplastic, aromatic polycarbonates, in particular those based on diphenols with the following formula (I):

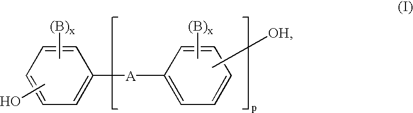

wherein:

A represents a simple bond, C₁-C₅ alkylene, C₂-C₅ alkylidene, C₅-C₆ cycloalkylidene, —S—, —SO₂—, —O—, —CO— or a C₆-C₁₂ arylene group, which if appropriate may be condensed with other aromatic rings containing heteroatoms

the B groups each independently represent a C₁-C₈ alkyl, C₆-C₁₀ aryl, particularly preferably phenyl, C₇-C₁₂ aralkyl, preferably benzyl, halogen, preferably chlorine, bromine,

x each independently represents 0, 1 or 2

p represents 1 or 0,

or alkyl-substituted dihydroxyphenyl cycloalkanes with the formula (II)

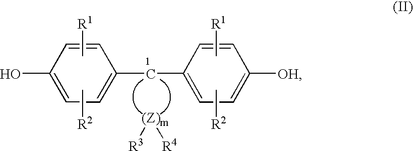

wherein:

R¹ and R² each independently represent hydrogen, halogen, preferably chlorine or bromine, C₁-C₈ alkyl, C₅-C₆ cycloalkyl, C₆-C₁₀ aryl, preferably phenyl and C₇-C₁₂ aralkyl, preferably phenyl C₁-C₄ alkyl, in particular benzyl,

m represents an integer from 4 to 7, preferably 4 or 5

R³ and R⁴ are each independently selected for each Z and represent hydrogen or C₁-C₆ alkyl preferably hydrogen, methyl, or ethyl,

and

Z represents carbon, with the proviso that on at least one Z atom, R³ and R⁴ simultaneously represent alkyl.

Suitable diphenols in formula (I) are, for example, hydroquinone, resorcinol, 4,4′-dihydroxydiphenyl, 2,2-bis(4-hydroxyphenyl)-propane, 2,4-bis(4-hydroxyphenyl)-2-methylbutane-, 1,1-bis(4-hydroxyphenyl)cyclohexane, 2,2-bis(3-chloro-4-hydroxyphenyl)propane, 2,2-bis(3,5-dibromo-4-hydroxyphenyl)propane.

Preferred diphenols in formula (I) are 2,2-bis(4-hydroxyphenyl)-propane, 2,2-bis(3,5-dichloro-4-hydroxyphenyl)propane and 1,1-bis(4-hydroxyphenyl)cyclohexane.

Preferred diphenols in formula (II) are dihydroxydiphenylcycloalkanes with 5- and 6-ring C atoms in the cycloaliphatic group [(m=4 or 5 in formula (II)], such as, for example, the diphenols corresponding to the formulae

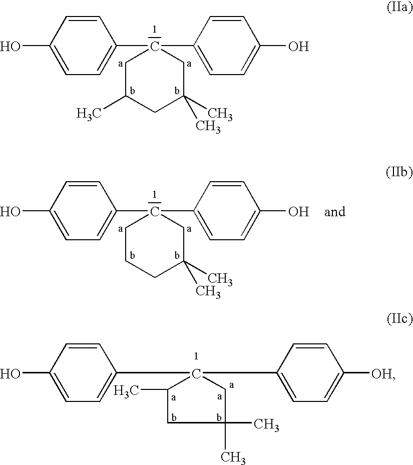

wherein the 1,1-bis(4-hydroxyphenyl)-3,3,5-trimethylcyclohexyne (formula (IIc) is particularly preferred.

The suitable polycarbonates according to the invention may be branched in a known manner and to be more precise preferably by the incorporation of 0.05 to 2.0 mol %, based on the sum of the diphenols used, of compounds which are trifunctional or more than trifunctional such as, for example, those compounds having three or more than three phenolic groups, for example:

phloroglucinol,

4,6-dimethyl-2,4,6-tri(4-hydroxyphenyl)heptene-2,

4,6-dimethyl-2,4,6-tri(4-hydroxyphenyl)heptane,

1,3,5-tri(4-hydroxyphenyl)benzene,

1,1,1-tri(4-hydroxyphenyl)ethane,

tri(4-hydroxyphenyl)phenylmethane,

2,2-bis(4,4-bis(4-hydroxyphenyl)cyclohexyl)propane,

2,4-bis(4-hydroxyphenyl)-isopropyl)phenol,

2,6-bis(2-hydroxy-5′-methylbenzyl)-4-methylphenol,

2-(4-hydroxyphenyl)-2-(2,4-dihydroxyphenyl)propane,

hexa(4-(4-hydroxyphenylisopropyl)phenyl)ortho-terephthalic ester,

tetra(4-hydroxyphenyl)methane,

tetra(4-(4-hydroxyphenylisopropyl)phenoxy)methane and

1,4-bis((4′-,4″-dihydroxytriphenyl)methyl)benzene.

Some of the other trifunctional compounds include 2,4-dihydroxybenzoic acid, trimesic acid, trimellitic acid, cyanuric chloride and 3,3-bis(3-methyl-4-hydroxyphenyl)-2-oxo-2,3-dihydroindole.

In addition to bisphenol A homopolycarbonate, preferred polycarbonates are the copolycarbonates of bisphenol A with up to 15 mol %, based on the molar sum of diphenols, of 2,2-bis(3,5-dibromo-4-hydroxyphenyl)propane.

The aromatic polycarbonates to be used may be partially replaced by aromatic polyester carbonates.

Aromatic polycarbonates and/or aromatic polyester carbonates are known from literature and/or can be prepared by methods known from literature (for the production of aromatic polycarbonates, see, for example, Schnell, “Chemistry and Physics of Polycarbonates”, Interscience Publishers, 1964 and DE-AS 1 495 626, DE-OS 2 232 877, DE-OS 2 703 376, DE-OS 2 714 544, DE-OS 3 000 610, DE-OS 3 832 396; for the production of aromatic polyester carbonates, for example, DE-OS 3 077 934).

Aromatic polycarbonates and/or aromatic polyester carbonates may be produced, for example, by the reaction of diphenols with carbonyl halides, preferably phosgene, and/or with aromatic dicarboxylic dihalides, preferably benzene dicarboxylic dihalides, by the phase interface process, optionally, with the use of chain stoppers and, optionally, with the use of branching agents which are trifunctional or more than trifunctional.

Also suitable as thermoplastic plastics are styrene copolymers of one or at least two ethylenically unsaturated monomers (vinyl monomers) such as, for example, of styrene, α-methylstyrene, ring-substituted styrenes, acrylonitrile, methacrylonitrile, methyl methacrylate, maleic acid anhydride, N-substituted maleimides and (meth)acrylic acid esters with 1 to 18 C atoms in the alcohol component.

The copolymers are resinous, thermoplastic and free from rubber.

Preferred styrene copolymers are those comprising at least one monomer from the series styrene, α-methylstyrene and/or ring-substituted styrene with at least one monomer from the series acrylonitrile, methacrylonitrile, methyl methacrylate, maleic acid anhydride and/or N-substituted maleic imide.

Particularly preferable weight ratios in the thermoplastic copolymer are 60 to 95% by weight of the styrene monomer and 40 to 5% by weight of the other vinyl monomers.

Particularly preferred copolymers are those comprising styrene with acrylonitrile, and, optionally, with methyl methacrylate, of α-methylstyrene with acrylonitrile and, optionally, with methyl methacrylate, or of styrene and α-methylstyrene with acrylonitrile, and, optionally, with methyl methacrylate.

The styrene-acrylonitrile copolymers are known and may be produced by radical polymerisation, in particular by emulsion, suspension, solution or bulk polymerisation. These copolymers preferably have molecular weights \overline{M}_{W} (weight average as determined by light scattering or by sedimentation) of between 15,000 and 200,000 g/mol.

Particularly preferred copolymers also include statistically built-up copolymers of styrene and maleic acid anhydride, which may preferably be produced from the corresponding monomer, with incomplete reactions, preferably by continuous bulk or solution polymerisation.

The proportions of these two components of the statistically built-up styrene-maleic acid anhydride copolymers which are suitable according to the invention can vary within wide limits. The preferred maleic acid anhydride content is from 5 to 25% by weight.

Instead of styrene, the polymers may also contain ring-substituted styrenes, such as ρ-methylstyrene, 2,4-dimethylstyrene and other substituted styrenes, such as α-methylstyrene.

The molecular weights (number average \overline{M}n) of the styrene-maleic acid anhydride copolymers can vary over a wide range. The range is preferably from 60,000 to 200,000 g/mol. A limiting viscosity of 0.3 to 0.9 (as measured in dimethylformamide at 25° C.; cf. Hoffmann, Kuhn, Polymeranalytik I, Stuttgart 1977, pages 316 et seq) is preferred for these products.

Also suitable for use as thermoplastic plastics are graft copolymers. These include graft copolymers which have rubber-like elastic properties and are substantially obtainable from at least 2 of the following monomers: chloroprene, 1,3-butadiene, isopropene, styrene, acrylonitrile, ethylene, propylene, vinyl acetate and (meth)acrylic acid esters with 1 to 18 C atoms in the alcohol component; i.e. polymers such as those as described in, for example, “Methoden der organischen Chemie” (Methods of organic chemistry) (Houben-Weyl), Vol. 14/1, Georg Thieme Verlag, Stuttgart, 1961, pp. 393-406 and in C. B. Bucknall “Toughened Plastics”, Appl. Science Publishers, London 1977. Preferred graft polymers are partially cross-linked and have gel contents of more than 20% by weight, preferably more than 40% by weight, in particular more than 60% by weight.

The preferred graft copolymers include, for example, copolymers consisting of styrene and/or acrylonitrile and/or alkyl (meth)acrylic acid alkyl esters grafted onto polybutadienes, butadiene-styrene copolymers and acrylic rubbers; i.e. copolymers such as those described in DE-OS 1 694 173 (=U.S. Pat. No. 3,564,077); polybutadienes, butadiene/styrene or butadiene/acrylonitrile copolymers, polyisobutenes or polyisoprenes grafted with alkyl acrylates or alkyl methacrylates, vinyl acetate, acrylonitrile, styrene and/or alkylstyrenes such as those described, for example, in DE-OS 2 348 377 (=U.S. Pat. No. 3,919,353).

Particularly preferred polymers are, for example, ABS polymers, such as those described in DE-OS 2 035 390 (=U.S. Pat. No. 3,644,574) or in DE-OS 2 248 242 (=GB-PS 1 409 275).

The graft copolymers can be prepared by known processes, such as, for example, bulk, suspension, emulsion or bulk-suspension processes.

The thermoplastic polyamides used may be polyamide 66 (polyhexamethylene adipinamide), or polyamides of cyclic lactams having 6 to 12 C (carbon) atoms, preferably of lauryl lactam and more preferably of ε-caprolactam=polyamide 6 (polycaprolactam), or copolyamides containing as chief components 6 or 66 or mixtures with the chief component of the said polyamides. Preferred is a polyamide 6 produced by activated anionic polymerisation or copolyamide produced by activated anionic polymerisation with polycaprolactam as the chief component.

b) Glass or Ceramic Materials

The ceramic materials particularly suitable for the ultraphobic surface and/or its substrate are oxides, fluorides, carbides, nitrides, selenides, tellurides, sulphides, in particular of metals, boron, silicon or germanium or mixed compounds thereof or physical mixtures of these compounds, in particular

oxides of zirconium, titanium, tantalum, aluminium, hafnium, silicon, indium, tin, yttrium or cerium,

fluorides of lanthanum, magnesium, calcium, lithium, yttrium, barium, lead, neodymium or aluminium in the form of cryolite (sodium aluminium fluoride, Na₃AlF₆)

carbides of silicon or tungsten,

sulphides of zinc or cadmium,

selenides and tellurides of germanium or silicon,

nitrides of boron, titanium or silicon.

In principle, glass is also suitable for the ultraphonic surface and/or its substrate. This includes all types of glass known to a person skilled in the art and described for example in the publications from H. Scholze “Glas, Natur, Struktur, Eigenschaften” (Glass, nature, structure, properties), Springer Verlag 1988 or the manual “Gestalten mit Glass” (Forming with glass), Interpane Glas Industrie AG, 5^{th} Edition 2000.

Preferably, the glass used for the substrate is an alkaline earth-alkali silicate glass based on calcium oxide, sodium oxide, silicon dioxide and aluminium oxide or a borosilicate glass based on silicon dioxide, aluminium oxide, alkaline earth metal oxides, boric oxide, sodium oxide and potassium oxide.

Particularly preferably, the substrate is an alkaline earth alkali silicate glass which is coated on its surface with an additional zirconium oxide layer with a thickness of 50 nm to 5 μm.

In particular suitable are the conventional alkaline earth alkali silicate glasses used for sheet glass and window glass applications comprising for example 15% calcium oxide, 13 to 14% sodium oxide, 70% silicon dioxide and 1 to 2% aluminium oxide. Also suitable are borosilicate glasses used, for example, as fire protection glass and comprising, for example, 70 to 80% silicon dioxide, 7 to 13% boric oxide, 2 to 7% aluminium oxide, 4 to 8% sodium and potassium oxide and 0 to 5% alkaline earth metal oxides.

c) Other Materials

Also suitable is carbon, in particular in a coating known to a person skilled in the art as a DLC (diamond-like-carbon) coating and described in the publication “Dünnschichtechnologie”, (Thin layer technology) Eds. H. Frey and G. Kienel, VDI-Verlag, Düsseldorf 1987. The DLC layer is preferably applied to a carrier material different from carbon.

Particularly preferably, the substrate is provided with an additional coating of a hydrophobic or oleophobic phobing agent.

d) Phobing Agents:

Hydrophobic or oleophobic phobing agents are surface-active compounds of any molar mass. These compounds are preferably cationic, anionic, amphoteric or non-ionic surface-active compounds, such as those listed, for example, in the dictionary “Surfactants Europa, A Dictionary of Surface Active Agents available in Europe, Edited by Gordon L. Hollis, Royal Society of Chemistry, Cambridge, 1995.

Examples of anionic phobing agents to mention are: alkyl sulphates, ether sulphates, ether carboxylates, phosphate esters, sulphosuccinates, sulphosuccinate amides, paraffin sulphonates, olefin sulphonates, sarcosinates, isothionates, taurates and lignin compounds.

Examples of cationic phobing agents to mention are: quaternary alkyl ammonium compounds and imidazoles.

Examples of amphoteric phobic agents are betaines, glycinates, propionates and imidazoles.

Non-ionic phobing agents are, for example: alkoxyates, alkyloamides, esters, amine oxides and alkylpolyglycosides. Also possible are: conversion products of alkylene oxides with compounds suitable for alkylation, such as for example fatty alcohols, fatty amines, fatty acids, phenols, alkyl phenols, arylalkyl phenols such as styrene phenol condensates, carboxylic acid amides and resin acids.

Particularly preferred are phobing agents in which 1 to 100%, particularly preferably 60 to 95%, of the hydrogen atoms are substituted by fluorine atoms. Examples mentioned are perfluorinated alkyl sulphate, perfluorinated alkyl sulphonates, perfluorinated alkyl phosphates, perfluorinated alkyl phosphinates and perfluorinated carboxylic acids.

Preferably used as polymer phobing agents for hydrophobic coating or as polymeric hydrophobic material for the surface are compounds with a molar mass M_{W}>500 to 1,000,000, preferably 1,000 to 500,000 and particularly preferably 1500 to 20,000. These polymeric phobing agents may be non-ionic, anionic, cationic or amphoteric compounds. In addition, these polymeric phobing agents may be homopolymers, copolymers, graft polymers and graft copolymers and statistical block polymers.

Particularly preferred polymeric phobing agents are those of the type AB-, BAB- and ABC block polymers. In the AB or BAB block polymers, the A segment is a hydrophilic homopolymer or copolymer and the B block a hydrophobic homopolymer or copolymer or a salt thereof

Particularly preferred are also anionic, polymeric phobing agents, in particular condensation products of aromatic sulphonic acids with formaldehyde and alkyl naphthaline sulphonic acids or from formaldehyde, naphthaline sulphonic acids and/or benzenesulphonic acids, condensation products from optionally substituted phenol with formaldehyde and sodium bisulphite.

Also preferred are condensation products which may be obtained by converting naphthols with alkanols, additions of alkylene oxide and at least the partial conversion of the terminal hydroxyl groups into sulpho groups or semi-esters of maleic acid and phthalic acid or succinic acid.

In another preferred embodiment of the method according to the invention, the phobing agent comes from the group of sulphosuccinates and alkylbenzenesulphonates. Also preferred are sulphated, alkoxylated fatty acids or the salts thereof. Preferably understood by alkoxylated fatty acid alcohols are in particular those C₆-C₂₂ fatty acid alcohols with 5 to 120, with 6 to 60, quite particularly preferably with 7-30 ethylene oxides, saturated or unsaturated, in particular stearyl alcohol. The sulphated alkoxylated fatty acid alcohols are preferably present as a salt, in particular as alkali or amine salts, preferably as diethylamine salt.

Quite particularly preferred is one in which an additional adhesion-promoting layer based on noble metals, preferably a gold layer with a layer thickness of from 10 to 100 nm is arranged between the phobing agent layer and the substrate.

The subject of the invention is also a method for the selection of optionally surface-coated substrates with ultraphobic and reduced light-scattering surfaces, in which

A) at least one optionally surface-coated substrate is selected with regard to the composition, thickness and sequence of individual layers,

B) the surface topography of each substrate according to A) is varied and in each case the total scatter per substrate is calculated and substrates with a surface topography with a total scatter of ≦7%, preferably ≦3%, particularly preferably ≦1% are selected,

C) the surface of the substrates selected according to B) is checked against the topographic condition for ultraphobic properties in accordance with the following equation:

S(log f)=a(f)·f (1)

whereby the integral of the function S(log f) between the integration limits log(f₁/μm⁻¹)=−3 and log (f₂/μm⁻¹)=3 is at least 0.3.

D) the substrates with surface topographies meeting the condition according to C) are selected.

The following describes the preferred details of steps A) to D) in more detail.

A) Selection of a Layer System Characterised by the Composition, Thickness and Sequence of Individual Layers

Suitable as substrates within the meaning of the invention are in principle all materials known to a person skilled in the art or combinations thereof. Preferably, the substrate involves the materials cited in points b and c above. The substrate can be coated or uncoated. The uncoated substrate has at least one layer. The coated substrate has at least two, but usually numerous, layers. The substrate is preferably selected according to its composition, the thickness of the layer in question, the thickness of the overall substrate and optionally the sequence of the individual layers.

However, when selecting the composition and layer sequence of the substrate, a person skilled in the art in particular takes into account additional properties to be satisfied by the surface of the substrate in the technical application in question. If, for example, a particularly high degree of scratch resistance is important for the application, a person skilled in the art will select particularly hard materials, for example TiN, SiC, WC or Si₃N₄.

A person skilled in the art is in principle aware of the conditions to be observed with the choice of layer material, layer thicknesses and the sequence of the layer structure with layer systems in order to avoid unwanted optical effects, such as absorption, colour casts (by absorption or interference) or reflections. On the other hand, it is also desirable in many cases selectively to provide optical properties such as layers which appear coloured, partially-reflecting or fully reflecting layers.

B) Calculation of the Total Scatter Losses for Different Surface Topographies and Selection of Topographies with a Total Scatter of ≦7%, Preferably ≦3%, Particularly Preferably ≦1%

The layer systems selected according to step A) are provided with different surface topographies and investigated with regard to their total scatter

The calculation or determination of the total scatter is known to a person skilled in the art and is performed numerous times in industry, e.g. for the development of optical components. The regulation used for the calculation is known, for example, from the publication by A. Duparré, Thin Films in Optical Coatings, CRC Press, Boca Raton, London 1995, which is cited here as a reference and hence deemed to be part of the disclosure. There, the following is given in equation 10:

$$ARS = {\sum }_{i} {\sum }_{j} {KC}_{i} {C}_{j}^{*} {PSD}_{ij} ( 2 π f ) \qquad ( 2 )$$

Here, ARS represents the angle-resolved scatter. The total scatter loss TS (total integrated scatter) is obtained by integrating the ARS via the forward half-space and the backward half-space:

$$TS = {\int }_{Ω} ARS ⅆ Ω \qquad ( 3 )$$

The optical factor K for the scatter in the backward half-space or forward half-space is determined in the publication of P. Bousquet, F. Flory, P. Roche “Scattering from multilayer thin films: theory and experiment”, J. Opt. Soc. Am. Vol. 71 (1981), according to the rules quoted following formulae 22 and 23 on p 1120 from the polar and azimuthal angle of incidence, the wavelength used and the refractive indices of the layer materials.

The optical factors Cᵢ, Cⱼ are calculated from formulae 22 and 23 in the publication of P. Bousquet, F. Flory, P. Roche “Scattering from multilayer thin films: theory and experiment”, J. Opt. Soc. Am. Vol. 71 (1981) as follows. Here, i and j designate the numbers of the interface. Conjugated complex values are marked with an asterisk (*). The factors Cᵢ and Cⱼ are calculated using the formulae 17, 18, 19 and 20 on page 1119 from the field strengths E at the layer interfaces and the rules given on page 1119 for the admittances Y. The admittances Y are calculated in accordance with the 4 formulae (not numbered) on page 1119, left column, last paragraph, from the refractive indices n, the dielectric constants, the magnetic field constants, the layer thicknesses e and the polar angle of incidence θ₀. The field strength calculations are performed using the usual recursion methods used by people skilled in the art to calculate layer systems; these are described on pages 1117 and 1118.

To perform the above-cited calculations, the optical refractive indices at the wavelength of scattering light are required, these are determined as follows:

As the reference wavelength here, 514 mm, is chosen, for example. The optical refractive indices at this wavelength are known for numerous materials. They may, for example, be taken from the publication Handbook of Optical Constants of Solids, Ed. E. D. Palik, Academic Press, San Diego, 1998, which is cited here as a reference and hence deemed to be part of the disclosure. If an optical refractive index is not known, it may also be determined by experimental means. The rule required for this is known to a person skilled in the art and may be taken for example, from the publication by H. A. Macleod, Thin Film Optical Filters, Macmillan Publishing Company New York; Adam Hilger Ltd., Bristol, 1986, which is cited here as a reference and hence deemed to be part of the disclosure.

For the observance of the total scatter losses of ≦7%, preferably ≦3%, particularly preferably ≦1%, different curves of the function PSD(f) may be determined in equation (1). The function PSD(f) is well known to a person skilled in the art as power spectral density and frequently used for the quantitative statistical description of the topography of surfaces. Details of this may be taken from the publication by J. C. Stover “Optical Scattering, 2^{nd} Edition, SPIE Press Bellingham, Wash., USA 1995, which is cited here as a reference and hence deemed to be part of the disclosure. For the set R of all the functions determined in this step R={PSD(f)}, there are surfaces with different topographies with total scatter losses of ≦7%, preferably ≦3%, particularly preferably ≦1%.

When selecting the functions PSD(F), the following restrictions are imposed in order to limit the choice to those functions which appear sensible to a person skilled in the art. Therefore, this excludes functional curves, which, although they meet the required scatter condition from a mathematical point of view, make no sense from a physical or technical point of view.

a) Only local frequencies in the range of f₁=10⁻³ μm⁻¹ and f₂=10⁻³ μm⁻¹ are taken into account.

b) The following is used as the upper limit of the function PSD(f):

log[PSDₘₐₓ(f)/nm⁴]=16−2 log[f/μm⁻¹] (4)

c) The following is used as the lower limit of the function PSD(f):

log[PSDₘᵢₙ(f)/nm⁴]=2−2 log[f/μm⁻¹] (5)

d) No discontinuous and no non-differentiable functional curves are taken into account. A person skilled in the art is familiar with the functional curves which are sensible and applicable. Literature contains a wide variety of functional curves for the function PSD(f). These may be used as a reference and as a comparison for the identification of artificial or physically nonsensical functions.

E. Church, M, Howells, T. Vorburger, “Spectral analysis of the finish of diamond-turned mirror surfaces”, Proc. SPIE 315 (1981) 202

J. M. Bennett, L. Mattsson, “Introduction to surface roughness and scattering”, OSA Publishing, Washington D.C. 1999, Chapter 5 “Statistics for selected surfaces”

C. Walsh, A. Leistner, B. Oreb, “Power spectral density analysis of optical substrates for gravitational-wave interferometry”, Applied Optics 38 (1999) 4790

D. Rönnow, “Interface roughness statistics of thin films from angle resolved light scattering at three wavelengths”, Opt. Eng. 37 (1998) 696

C. Vernold, J. Harvey, “Effective surface PSD for bare hot isostatic pressed (HIP) beryllium mirrors”, Proc. SPIE 1530 (1991) 144

A. Duparré, G. Notni, R. Recknagel, T. Feigl, S. Gliech, “Hochauflösende Topometrie im Kontext globaler Makrostrukturen” (Highly resolved topometry in the context of global macrostructures), Technisches Messen 66 (1999) 11

R. Recknagel, T. Feigl, A. Duparre, G. Notni, “Wide scale surface measurement using white light interferometry and atomic force microscopy”, Proc. SPIE 3479 (1998) 36

S. Jakobs, A. Duparré, H. Truckenbrodt, “Interfacial roughness and related scatter in ultraviolet optical coatings: a systematic experimental approach”, Applied Optics 37 (1998) 1180

V. E. Asadchikov, A. Duparré, S. Jakobs, A. Yu. Karabekov, I. V. Kozhevnikov, “Comparative study of the roughness of optical surfaces and thin films by x-ray scattering and atomic force microscopy”, Applied Optics 38 (1999) 684

E. Quesnel, A. Dariel, A. Duparré, J. Steinert, “VUV Light Scattering and Morphology of Ion Beam Sputtered Fluoride Coatings”, Proc. SPIE 3738 (1999)

C. Ruppe and A. Duparré “Roughness analysis of optical films and substrates by atomic force microscopy”, Thin Solid Films 288 (1996) 8

These publications are cited here as a reference and hence are deemed to be part of the disclosure.

C) Testing the Selected Surface Topographies According to Step B) for Ultraphobic Properties

For the set of the R={PSD(f)} functions selected in B), a computer is now used to check which subset T={PSD(f)} ⊂R={PSD(f)} of surface topographies, i.e. PSD(f) functions, has ultraphobic properties. For this, frequency-dependent amplitudes a(f) are determined from the PSD(f) curves according to the following formula.

$$a ( f ) = \sqrt{4 π {\int }_{f / \sqrt{D}}^{f \sqrt{D}} PSD ( {f}^{′} ) {f}^{′} ⅆ {f}^{′}} \approx 2 f \sqrt{π PSD ( f ) log D} \qquad ( 6 )$$

Here, the value D=1.5 was used as the constant D which determines the width of the integration interval and within which the function PSD(f) is regarded as constant. This formula corresponds in principle to the calculation of spatial-frequency dependent amplitudes, which is also described in J. C. Stover, Optical Scattering, 2^{nd} Edition, SPIE Press Bellingham, Wash., USA 1995 in formula (4.19) on page 103, and in Table 2.1 on page 34 and Table 2.2 on page 37.

International application PCT/99/10322, describes for example, ultraphobic surfaces, for which the structure of the surface topography is built up such that the value of the integral of a function S

S(log f)=a(f)·f (7)

which indicates a relationship between the spatial frequencies f of the individual Fourier components and their amplitudes a(f), between the integration limits log(f₁/μm⁻¹)=−3 and log(f₂/μm⁻¹)=3, is at least 0.5, and which comprise a hydrophobic or in particular oleophobic material or are coated in particular with a hydrophobic or in particular oleophobic material. Also preferably, the value of the integral is at least 0.3.

The relation (7) is now used to calculate for all PSD(f) functions of the set R={PSD(f)} the value of the integral of the function S(log f) between the integration limits log(f₁/μm⁻¹)=−3 and log(f₂/μm⁻¹)=3. All PSD(f) functions whose integral is ≧0.3 are summarised as the set T={PSD(f)}. For topographies which are described by these functions PSD(f), there is a total scatter loss of ≦7%, preferably ≦3%, particularly preferably ≦1% and an ultraphobic property resulting in an contact angle in relation to water of ≧140°.

D) Selection of the Layer Systems Meeting Both Conditions from Step B) and Step C)

If there now exist preferably calculated surface topographies PSD(f), which meet both properties, which are therefore calculated to be ultraphobic and reduced light-scattering, it is therefore reliably ensured that the selected layer structure may be produced by the suitable structuring of a surface of this kind. Of the numerous possible layer structures, only selected layers are able to meet both conditions, ultraphobia and reduced light scatter. The preferably calculated preselection of steps A) to C) enables much unnecessary experimental work on the optimisation of the layers to be avoided.

Steps A) to C) may be supported or automated in a suitable way by computer equipment. The amount of computing required to check an individual layer structure is so low that a large number of layer structures may be checked numerically within a short time.

The computer programs may in particular be structured so that steps A) to C) are performed in a manner in which the layer structures may be numerically optimised. This is explained with the following example:

In step A) a substrate made of a material a) with a layer thickness dₐ₁ and an refractive index nₐ is selected. After checking the condition for reduced light scattering in step B) and the condition for ultraphobia in step C), the topographies for which both conditions apply are selected. The substrate thickness dₐ₁ is then increased by one increment Δd to dₐ₂=dₐ₁+Δd. After re-checking the conditions in steps B) and C), it is now possible to determine whether the set of significantly different topographies has changed on the basis of the corresponding PSD(f) functions. Calculation cycles of the kind in steps A) to C) may now be performed until the substrate thickness dₒₚₜ is determined within a specified interval for which the set of significantly differently topographies Tₒₚₜ={PSD(f)} is the greatest on the basis of the corresponding PSD(f) functions. The substrate thickness dₒₚₜ represents an optimum in so far as here the most different surface topographies are present for which both conditions from step B) and C) are observed. Therefore, it is principle simplest to perform a structuring of the surface with the desired properties at the substrate thickness dₒₚₜ as this is where the most possibilities exist.

A similar method may be employed if the layer thicknesses of substrates comprising several layers are to be optimised, e.g. for a 2-layer system with the structure of the layers (a, b) with the layer thicknesses dₐ and d_{b}. Here, it is possible to determine within the specified minimum and maximum layer thicknesses of the layers a and b the optimum regarding the layer thicknesses (d_{opt a}, d_{opt b}).

A similar method may also be employed with more complicated systems comprising three and more layers.

Preferably, the method according to the invention is used to investigate the substrates according to the invention.

Another subject of the invention is a method for the selection of process parameters for the production of ultraphobic and reduced light-scattering surfaces on optionally surface-coated substrates, in which:

E. the surfaces of substrates are produced with the variation of the process parameters required for the creation of the surface topography, serially or in parallel, preferably in parallel,

F. the total light scattering of all the surfaces determined according to E) is determined,

G. the contact angle of a water droplet is determined at least on the surface whose light scattering according to F) is ≦7%, preferably ≦3%, particularly preferably ≦1%, and

H. the substrates on the surface of which a water droplet has a contact angle of ≧140°, preferably ≧150° and the light scattering of which is ≦7%, preferably ≦3%, particularly preferably ≦1% are identified and the process parameters for their production selected.

The following explains the preferred details of steps E) to H) in more detail.

E) Production of Layer Systems with the Variation of the Process Parameters Required for the Creation of the Surface Topography (Serial or Parallel)

A person skilled in the art would find it easy to propose technically suitable coating methods for the selected substrates or optionally substrates comprising several layers with ultraphobic and reduced light-scattering properties.

In principle possible here are all processes which may be used to coat the surfaces of solid bodies with a layer. These thin-layer techniques may generally be divided into 3 categories: coating processes from the gaseous phase, coating processes from the liquid phase and coating techniques from the solid phase.

Examples of coating processes from the gaseous phase include various vaporisation methods and glow discharge processes, such as:

cathode sputtering

vapour deposition with or without ion assistance, whereby the vaporisation source may be operated by numerous different techniques, such as: electron beam heating, ion beam heating, resistance heating, radiation heating, heat by radio frequency induction, heating by arcs with electrodes or lasers,

chemical vapour deposition (CVD)

ion plating

plasma etching of surfaces

plasma deposition

ion etching of surfaces

reactive ion etching of surfaces

Examples for coating processes from the liquid phase are:

electrochemical deposition

sol-gel coating technology

spray coating

coating by casting

coating by immersion

coating by spin-on deposition (spin coating in “spin-up” mode or “spin coating” in “spin down” mode)

coating by spreading

coating by rolling.

Examples of coating processes from the solid phase are:

combination with a prefabricated solid film, for example by lamination or bonding

powder coating methods.

A selection of different thin-layer techniques which may be used for these purposes is also given in the publication Handbook of Thin Film Deposition Processes and Techniques, Noyes Publications, 1988, which is cited here as a reference and hence is deemed to be part of the disclosure.

A person skilled in the art is also familiar with the process parameters of the selected coating process which in principle influence the roughness or the topography of the surface.

For example, for the production of thin layers on glass by deposition, the following process parameters are significant with regard to the topography of the surface: substrate pretreatment (e.g. glowing, cleaning, laser treatment), substrate temperature, rate of vaporisation, background pressure, residual gas pressure, parameters during reactive deposition (e.g. partial pressure of the components), heating/irradiation after vaporisation, ion assistance parameters during vaporisation.

A person skilled in the art knows the parameters for other coating methods, in particular those substantial for influencing the topography, and selects them as appropriate, as explained with the example of vaporisation.

In addition to varying the process parameters for the coating process, it is also possible to pre-treat or post-treat the surface or to pre-treat or post-treat the surface with different process parameters to change the topography of the surface. This is performed for example by thermal treatment, plasma etching, ion beam irradiation, electrochemical etching, electron beam treatment, treatment with a particle beam, treatment with a laser beam or by mechanical treatment through direct contact with a tool.

A person skilled in the art is familiar with which process parameters of the selected treatment process in principle influence the roughness or topography of the surface.

The optimum setting for the roughness-determining process parameters of the coating process may be performed simply by checking a large number of different process parameter settings. Here, the following procedure is followed:

A predetermined surface topography for a substrate is produced with different partial surfaces a, b, c etc., preferably chemically, mechanically and/or thermally.

Also preferred is a substrate on different partial surfaces a, b, c, etc. coated with a layer whereby a different set of process parameters is set for each partial surface.

For example, for a deposition process, different deposition rates may be selected for each of the partial surfaces. The partial surfaces may be coated serially or, with the aid of suitable equipment, also in parallel.

In the case of serial coating, preferably the entire substrate is coated by a suitable masking device and only the partial surface a, which is to be coated in this step, is not protected by the mask. The mask may take the form of an opening in a curtain which is close to the substrate to be coated.

In one possible embodiment, the mask may take the form of a fixed opening in a curtain. The substrate then moves during the coating of the individual partial surfaces a, b, c etc. relative to the curtain with the diaphragm opening whereby either the substrate and/or the curtain is moved with the diaphragm opening.

In another embodiment, the diaphragm does not take the form of a fixed opening in a curtain, but the curtain itself consists of several parts moving in relation to each other, which depending on their positions, optionally reveal an opening at different points of the curtain.

In another embodiment, however, the mask may also take the form of a photoresist coating on the substrate, whereby the photoresist coating on the partial surface a, which is to be coated in this step, is exposed, developed and removed. After coating the partial surface a and before coating the next partial surface b, the partial surface a is coated again with a protective layer, which protects it from receiving a new coating during all subsequent coating processes of partial surfaces b, c, etc.

All masking techniques of this type are very familiar to a person skilled in the art for the structuring of coatings and are, for example, extensively used in semi-conductor technology. The use of mechanical masks in a wide variety of embodiments has been common practice for thin-layer technologies by vaporisation or cathode sputtering for a long time. An overview of photolithographic masking techniques may be found in the publications by Sze, VLSI Technology, McGraw Hill, 1983 and Mead et al., Introduction to VLSI Techniques, Addison-Wesley, 1980, which are included here as references and hence deemed to be part of the disclosure.

If the substrate temperature is used as a process parameter for an vaporisation process, another temperature Tₐ, T_{c}, T_{b}-Tₙ may be selected at each partial surface a, b, c-n and the coating of the entire substrate with all partial surfaces performed in parallel.

The automated production of a sample series of this kind is familiar to a person skilled in the art and corresponds in principle to the procedure used for the automated production of individual layers.

The procedure is in principle not restricted to one deposition process, but may be used for all coating methods listed under E).

The partial surfaces may lie on a common substrate or also on several substrates. In the case of a common substrate, the partial surfaces may be arranged in any order, i.e. for example in a square field or also in a rectangular or linear field.

The size of the partial surfaces is ≦9 cm², preferably ≦4 cm² particularly preferably ≦1 cm² and quite particularly preferably ≦0.4 cm². The total number of the different partial surfaces is ≧10, preferably ≧100 and quite preferably ≧10⁴.

F) Determination of the Total Scatter of all Surfaces Created in Step E)

Finally, all the surfaces created in step E) are tested for their total scatter losses. For this, the partial surfaces are secured in a measuring setup which is described in ISO/DIS 13696 and, for example, in the publication of Duparré and S. Gliech, Proc. SPIE 3141, 57 (1997). For this, a light source at 514 nm is used to illuminate a partial region of the partial surface or the entire surface by means of a scanning device. During the illumination, a collecting element (Ulbricht sphere or Coblentz sphere) is used to determine in sequence the total scatter losses in the backward half-space and the forward half-space.

In addition to the determination of the total scatter losses, it is also possible to determine other layer properties. For example, here it makes sense to measure scratching resistance and abrasion resistance if the surfaces are exposed to particularly high scratching or abrasion stresses, e.g. screens in automobiles.

The abrasion resistance is determined using the Taber Abraser method according to ISO 3537 with 500 cycles with 500 g per abrading wheel and CS10F abrading wheels. Then, the increase in haze is tested in accordance with ASTM D 1003.

Scratching resistance is determined using the sand trickling test according to DIN 52348. Then the increase in haze is tested according to ASTM D 1003.

F2) Coating of the Different Surfaces Created According to Step E) with a Gold Layer of 10 to 100 nm and a Monolayer of a Phobing Agent (Decanthiol)

In order to compare the different surface topographies with regard to their ultraphobic properties, coating is preferably performed with a uniform phobing agent. The choice of a uniform phobing agent enables the investigation of the very different topographies, which is in principle suitable for the formation of ultraphobic surfaces with low scatter.

Preferably, the coating is performed with an alkyl thiol, particularly preferably with decanthiol. Preferably, the decanthiol is obtained from a solution of 1 g/l in ethanol over 24 h by absorption at room temperature. Firstly, a layer of adhesion promoter is applied in a thickness of 10 nm to 100 nm, preferably gold, silver or platinum. The application of the adhesion promoter is preferably performed by cathode spluttering.

The coating with a phobing agent is preferably performed on all partial surfaces simultaneously.

G) Determination of the Contact Angle of all Surfaces Created in Step F) and Optionally F2)

Then, the contact angle of the test liquid, preferably water, on the partial surfaces is determined. The determination of the roll-off angle is determined, for example, by inclining the flat substrate until the drop of test liquid rolls off.

H) Selecting the Coated Surfaces from Step F) and Optionally F2) with a Contact Angle of ≧140°, Preferably ≧150° and a Total Light Scattering of ≦7%, referably ≦3%, Particularly Preferably ≦1%

Here, all the surfaces or settings of the process parameters for the coating process used are selected for which there is a contact angle of ≧140°, preferably ≧150° and a total light scattering of ≦7%, preferably ≦3%, particularly preferably ≦1%.

Depending upon the result obtained, steps E-H may be repeated for other coating process parameters.

Following the selection of the surfaces with a contact angle of ≧140°, preferably ≧150° and a total light scattering of ≦7%, preferably ≦3%, particularly preferably ≦1%, the coating method process parameters are used to produce larger quantities of the substrate with the surface. This production is performed in accordance with the process parameters selected in step H.

The subject of the invention is also a material or building material with an ultraphobic and transparent surface according to the invention and which is produced using the method according to the invention.

There are numerous possible technical applications for the surfaces according to the invention. The subject of the invention is therefore also the following applications of the inventive phobic and reduced light-scattering surfaces:

In the case of transparent materials, the phobic surfaces may be used as screens or covering layers for transparent screens, in particular glass or plastic screens, in particular for solar cells, vehicles, aeroplanes or houses.

Another application is facade elements for buildings to protect them from moisture.

### EXAMPLE

ZrO₂ with a 1 μm layer thickness as a single layer was selected. An optical refractive index of 2.1 was taken from literature familiar to a person skilled in the art.

For this layer configuration and a glass substrate with the refractive index 1.52, the total light scatter loss at a wavelength of 514 nm was determined for different assumed surface topographies with different degrees of roughness according to the regulation in step B).

A topography with a particularly preferred scatter loss of ≦1% was selected. The calculated total scatter loss in the forwards and backwards directions for this topography was 0.8%.

For this topography, to check the ultraphobic properties, the integral of the function S(log f) was calculated as described under step C) and a value of 0.42 obtained.

Since, according to this result, surface topographies exist for this layer system which meet the conditions “ultraphobic” and “reduced light-scattering”, the system was selected for experimental implementation.

Electron beam deposition was selected as the coating process. A flat glass substrate with a diameter of 25 mm and a thickness of 5 mm was cleaned in an automatic cleaning line (sequence: alkaline bath, rinsing in water, alkaline bath, rinsing in water, 2× rinsing in deionised water with subsequent drying by draining).

In the vaporisation process, the topography-sensitive process parameters “substrate temperature” and “vaporisation rate” were varied. Here, 10 different substrate temperatures of between 300 K and 700 K were selected plus 10 different vaporisation rates of between 0.1 nm/sec and 10 nm/sec.

For the samples obtained, the total scattering at a wavelength of 514 nm was determined in the forward and backward directions. The scatter losses were less than 1% for each sample.

The samples produced in this were coated with an approximately 50 nm thick gold layer by cathode sputtering. Finally, the samples were coated for 24 hours by immersion in a solution of 1-n-perfluorooctane thiol in α,α,α-trifluorotoluene (1 g/l) at room temperature in a closed vessel and then rinsed with α,α,α-trifluorotoluene and dried.

Then, the contact angle for these surfaces was determined. One of the surfaces had a statistical contact angle in relation to water of 153°. When the surface was inclined by <10°, a water droplet with a volume of 10 μl rolled off.

The process parameters of this surface were:

electron beam vaporisation with a substrate temperature of 573 K, a rate of 0.35 nm/s at a pressure of 1×10⁻⁴ mbar.

The scatter losses determined for this surface at a wavelength of 514 nm in the backward and forward directions in accordance with ISO/DIS 13696 were 0.1% in backscattering and 0.18% in forward scattering.

The value of the integral of the function

S(log f)=a(f)·f (8)

calculated between the integration limits log(f₁/μm⁻¹)=−3 and log(f₂/μm⁻¹)=3 is 0.4.

1. Substrate with reduced light-scattering ultraphobic surface with a total scatter loss of ≦7%, preferably ≦3%, particularly preferably ≦1% and a contact angle in relation to water of at least 140°, preferably at least 150°.

2. Substrate according to claim 1, characterised in that the abrasion resistance of the surface determined by an increase in haze according to test method ASTM D 1003 is from ≦10%, preferably from ≦5%, relative to an abrasion load with a Taber Abraser method according to ISO 3537 with 500 cycles, a weight of 500 g per abrading wheel and CS10F abrading wheels.

3. Substrate according to claim 1 or 2, characterised in that the resistance to scratching of the surface determined by an increase in haze according to test method ASTM D 1003 is from ≦15%, preferably from ≦10%, particularly preferably from ≦5% relative to a scratching load in a sand trickling test according to DIN 52348.

4. Substrate according to any one of claims 1 to 3, characterised in that for a water droplet of volume 10 μl, a roll-off angle is ≦20°,

5. Substrate according to any one of claims 1 to 4, characterised in that the substrate comprises plastic, glass, ceramic or carbon, optionally in transparent form.

6. Substrate according to claim 5, characterised in that the ceramic material is an oxide, fluoride, carbide, nitride, selenide, telluride or sulphide of a metal, or boron, silicone, germanium or mixed compounds thereof or physical mixtures of these compounds, in particular
an oxide of zirconium, titanium, tantalum, aluminium, hafnium, silicon, indium, tin, yttrium or cerium,
a fluoride of lanthanum, magnesium, calcium, lithium, yttrium, barium, lead, neodymium or cryolite (sodium aluminium fluoride, Na₃AlF₆),
a carbide of silicon or tungsten,
a sulphide of zinc or cadmium,
a selenide or telluride of germanium or silicon,
or a nitride of boron, titanium or silicon.

7. Substrate according to claim 5, characterised in that an alkaline earth alkali silicate glass based on calcium oxide, sodium oxide, silicon dioxide and aluminium oxide or a borosilicate glass based on silicon dioxide, aluminium oxide, alkaline earth metal oxides, boric oxide, sodium oxide and potassium oxide is used as glass,

8. Substrate according to claim 7, characterised in that the substrate material is an alkaline earth alkali silicate glass and that the substrate is coated on its surface with an additional zirconium oxide layer with a thickness of 50 nm to 5 μm.

9. Substrate according to claim 5, characterised in that a DLC layer (diamond-like carbon layer) on a carrier material different therefrom for the substrate is used as carbon, optionally in transparent form.

10. Substrate according to claim 5, characterised in that a thermosetting or thermoplastic plastic and/or the substrate surface is used as plastic, optionally in transparent form.

11. Substrate according to claim 10, characterised in that the thermosetting plastic is a diallyl phthalate resin, an epoxy resin, a urea-formaldehyde resin, a melamine-formaldehyde resin, a melamine-phenolic-formaldehyde resin, a phenolic-formaldehyde-resin, a polyimide, a silicone rubber, an unsaturated polyester resin or any possible mixture of the said polymers.

12. Substrate according to claim 10, characterised in that the thermoplastic plastic is a polyolefin, preferably polypropylene or polyethylene, a polycarbonate, a polyester carbonate, a polyester, preferably polybutylene-terephthalate or polyethylene-terephthalate, a polystyrene, a styrene copolymer, a styrene-acrylonitrile resin, a rubber-containing styrene graft copolymer, preferably an acrylonitrile-butadiene-styrene polymer, a polyamide, a polyurethane, a polyphenylene sulphide, a polyvinyl chloride or any possible mixture of the said polymers.

13. Substrate according to any one of claims 1 to 12, characterised in that the substrate has an additional coating with a hydrophobic or oleophobic phobing agent.

14. Substrate according to claim 13, characterised in that that the phobing agent is a cationic, anionic, amphoteric or non-ionic surface-active compound.

15. Substrate according to any one of claims 13 to 14, characterised in that an additional adhesion-promoting layer based on noble metals, preferably a gold layer with a layer thickness of from 10 to 100 nm is arranged between the phobing agent layer and the substrate.

16. Method for the selection of optionally surface-coated substrates with ultraphobic and reduced light-scattering surfaces, in particular those according to claims 1 to 15, characterised in that
A at least one optionally surface-coated substrate is selected with regard to the composition, thickness and sequence of individual layers,
B the surface topography of each substrate according to A) is varied and in each case the total scatter loss of the substrates is calculated and substrates with a surface topography with a total scatter of ≦7%, preferably ≦3%, particularly preferably ≦1% are selected,
C the surfaces of the substrates selected according to B) are checked against the topographic condition for ultraphobic properties in accordance with the following equation:
S(log f)=a(f)·f (9)
whereby the integral of the function S(log f) between the integration limits log(f₁/μm⁻¹)=−3 and log(f₂/μm⁻¹)=3 is at least 0.3,
D. the substrates with surface topographies meeting the condition according to C) are selected.

17. Method for the selection of process parameters for the production of ultraphobic and reduced light-scattering surfaces of optionally surface-coated substrates, characterised in that
E. the surfaces of substrates are produced by way of variation of the process parameters required for the creation of the surface topography, serially or in parallel, preferably in parallel,
F. the total light scattering of all the surfaces produced according to E) is determined,
G. the contact angle of a water droplet is determined at least on the surface whose light scattering according to B) is ≦7%, preferably ≦3%, particularly preferably ≦1%, and
H. the substrates on the surfaces of which a water droplet has a contact angle ≧140°, preferably ≧150° and the light scattering of which is ≦7%, preferably ≦3%, particularly preferably ≦1% are identified and the process parameters for their production selected.

18. Method according to claim 17, characterised in that the surface is the surface of a substrate selected according to claim 16.

19. Method according to claim 17 to 18, characterised in that the surface topography is created by chemical, thermal and/or mechanical means.

20. Method according to claim 17 or 18, characterised in that the surface topography is created by surface coating.

21. Method according to claim 20, characterised in that after the surface coating, post-treatment of the substrates with a process takes place optionally with the variation of the process parameters necessary for changing the surface topography.

22. Method according to any one of claims 20 to 21 characterised in that before the surface coating of the substrates, a pre-treatment of the substrates with a process takes place optionally with the variation of the process parameters necessary for changing the surface topography.

23. Method according to any one of claims 17-22, characterised in that before measuring the contact angle according to C), the surfaces are coated with a phobing agent.

24. Method according to claim 23, characterised in that before the coating with a phobing agent, the substrates are coated with a noble metal layer, preferably a gold layer with a thickness of 10 to 100 nm and that the phobing agent layer is a monolayer of a thiol, preferably decanthiol.

25. Method according to any of claims 17 to 24, characterised in that a substrate has at least two partial surfaces created with different process parameters.

26. Method according to claim 25, characterised in that the substrate has ≧10, preferably ≧100, particularly preferably ≧10⁴ partial surfaces created with different process parameters.

27. Method according to claim 26, characterised in that the size of the partial surfaces on the substrate created with different process parameters is ≦9 cm², preferably ≦4 cm², quite particularly preferably ≦0.4 cm².

28. Method according to claims 25 to 27, characterised in that the production of the partial surface in question takes place by means of a mask with which one or more partial surfaces on the substrate are covered during the production and the mask is removed again after production.

29. Method according to claim 28, characterised in that the mask is a photoresist layer.

30. Method for the production of ultraphobic and reduced light-scattering surfaces of optionally surface-coated substrates, characterised in that the process parameters selected with the method according to any one of claims 17-29 are used for the production thereof.

31. Material or building material which has a substrate according to any one of claims 1 to 15 or a surface produced according to claim 30.

32. Use of the substrates according to any one of claims 1 to 15 or the materials or building materials according to claim 30 as a transparent screen or a covering layer for transparent screens, in particular glass or plastic screens, in particular for solar cells, vehicles, aeroplanes or houses.

33. Use of the substrates according to any one of claims 1 to 15 or the materials and building materials according to claim 30 as non-transparent external elements of buildings, vehicles or aeroplanes.
